(19) United States
(12) Patent Application Publication
(10) Pub. No.: US 2025/0282523 A1
(43) Pub. Date: Sep. 11, 2025

(54) FIBER REINFORCED PALLETS

(71) Applicant: Polymer Solutions International, Inc., Medford, NJ (US)

(72) Inventors: Walter T. Blanchard, Alamo Heights, TX (US); John A. Spadavecchia, Atlantic Beach, NC (US)

(73) Assignee: Polymer Solutions International, Inc., Medford, NJ (US)

(21) Appl. No.: 18/859,817

(22) PCT Filed: Apr. 20, 2023
(86) PCT No.: PCT/US2023/019192

§ 371 Date: Oct. 24, 2024

Related U.S. Application Data
(60) Provisional application No. 63/334,369, filed on Apr. 25, 2022.

(51) Int. Cl. B65D 19/00; B29C 64/106; B29C 64/393; B29L 31/00; B33Y 10/00; B33Y 50/02; B33Y 70/10; B33Y 80/00

(52) U.S. Cl. CPC B65D 19/0036; B29C 64/106; B29C 64/393; B33Y 10/00; B33Y 70/10; B33Y 80/00; B29L 2031/7178; B33Y 50/02; B65D 2519/00034; B65D 2519/00044; B65D 2519/00069; B65D 2519/00079; B65D 2519/0086

(57) ABSTRACT

A reinforced plastic pallet includes a pallet deck having a lower deck surface and an opposing upper deck surface, and the upper deck surface is configured for contacting goods. The reinforced plastic pallet includes one or more pallet legs extending between the lower deck surface and a base layer, wherein the base layer is reinforced with a fiber layer. A method for manufacturing a fiber-reinforced pallet having a thermoplastic part includes programming a controller with a pallet assembly profile; moving the thermoplastic part relative to a heat source to form a melted surface on the thermoplastic part; and depositing a fiber-reinforced material onto the melted surface according to the pallet assembly profile. The method may include entangling the fiber-reinforced material with the melted surface; and cooling the melted surface.

### CROSS-REFERENCE TO RELATED APPLICATION

This application claims priority to U.S. Provisional Application No. 63/334,369, filed Apr. 25, 2022, and the contents of which are incorporated herein by reference in their entireties for all purposes.

### FIELD

The present disclosure relates to pallets for the transportation and/or handling of goods.

### BACKGROUND

A pallet is used to support, store, and/or transport goods in bulk. It is known to construct pallets from various materials, such as wood or plastic. Pallets constructed from plastic may provide desirable impact performance and durability compared to conventional wooden pallets, but other mechanical properties of wooden pallets (such as, e.g., resistance to deformation) are challenging to replicate, leading to increased material usage, increased weight, increased manufacturing complexity, and or potential corrosion.

### SUMMARY OF THE INVENTION

Aspects of the present invention are directed to pallet systems.

In accordance with one aspect of the present invention, a reinforced plastic pallet is disclosed. The pallet comprises a pallet deck having a lower deck surface and an opposing upper deck surface. The upper deck surface is configured for contacting goods. The pallet includes one or more pallet legs extending between the lower deck surface and a base layer, wherein the base layer is reinforced with a fiber layer.

In accordance with another aspect of the present invention, a method for manufacturing a fiber-reinforced pallet having a thermoplastic part is disclosed. The method comprises programming the controller with a pallet assembly profile; moving the thermoplastic part relative to a heat source to form a melted surface on the thermoplastic part; and depositing a continuous fiber-reinforced material onto the melted surface according to the pallet assembly profile.

In accordance with another aspect of the present invention, a method for manufacturing a fiber-reinforced pallet having a thermoplastic part is disclosed. The method comprises the steps of placing a thermoplastic part in proximity to a pellet extruder, the pellet extruder having an extruder head; loading pellets comprising thermoplastic material into the pellet extruder; heating the pellets in the pellet extruder until at least some of the pellets become plasticized material; moving the extruder head relative to the thermoplastic part so that the extruder head faces a predetermined target point on a surface of the thermoplastic part; advancing a portion of the plasticized material out of the extruder head and directly onto the surface of the thermoplastic part at the predetermined target point; and cooling said first portion of the plasticized material to permanently fuse it to the surface of the thermoplastic part at the predetermined target point.

### BRIEF DESCRIPTION OF THE DRAWING FIGURES

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 depicts a fiber-reinforced pallet according to one example;

FIG. 2 is an exploded view of the pallet of FIG. 1;

FIG. 3A depicts a pallet according to another example;

FIG. 3B is a partial cross-section view of the pallet of FIG. 3A, showing a location of a fiber layer;

FIG. 4A depicts a pallet according to yet another example;

FIG. 4B is a partial cross-section view of the pallet of FIG. 4A, showing another location of the fiber layer; and

FIGS. 5 and 6 each illustrate an exemplary method of manufacturing a fiber-reinforced pallet.

### DETAILED DESCRIPTION OF THE INVENTION

Aspects of the invention are described herein with reference to handling (e.g. storing, transporting, etc.) goods, such as food, pharmaceutical products, and other items known in the art. It will be understood by one of ordinary skill in the art that the example pallets described herein may be used to transport a variety of goods, and are not limited to any goods or product disclosed herein. Further, it will be appreciated that throughout this specification, the term “pallet floor” or “floor” is to be broadly construed as a surface configured to be in contact with the pallet, such as the floor of an industrial or working environment (e.g. warehouse), a level of a pallet racking system (e.g. shelves or racks), a vehicle surface (i.e. vehicle is broadly defined as any machine used for transporting goods from one location to another), or a combination thereof.

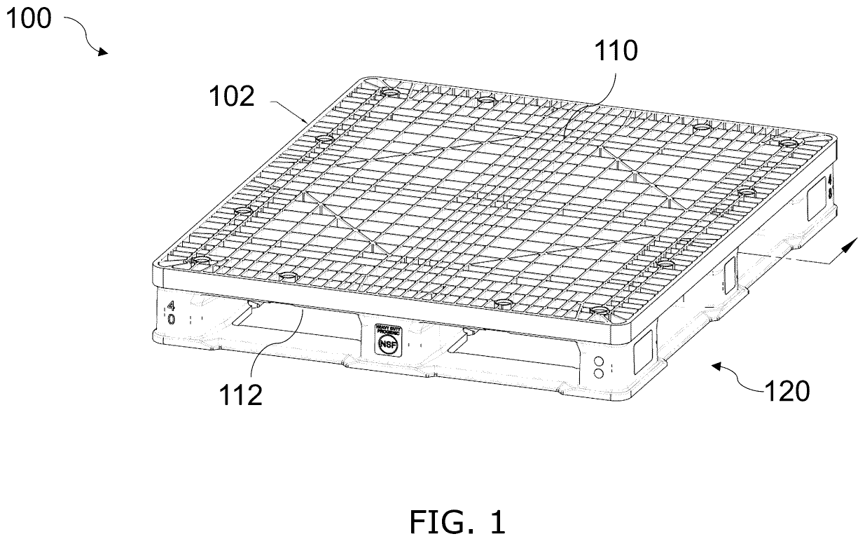

With reference to the drawings, FIG. 1 shows an exemplary reinforced plastic pallet 100. In a non-limiting example, the plastic pallet 100 is adapted for use in handling or transporting sensitive goods requiring antimicrobial or sanitary materials, such as food. Generally, plastic pallet 100 comprises a pallet deck 102, a base layer 120, a fiber layer 106, and one or more pallet legs 108. Individual components of pallet 100 will now be described in detail below.

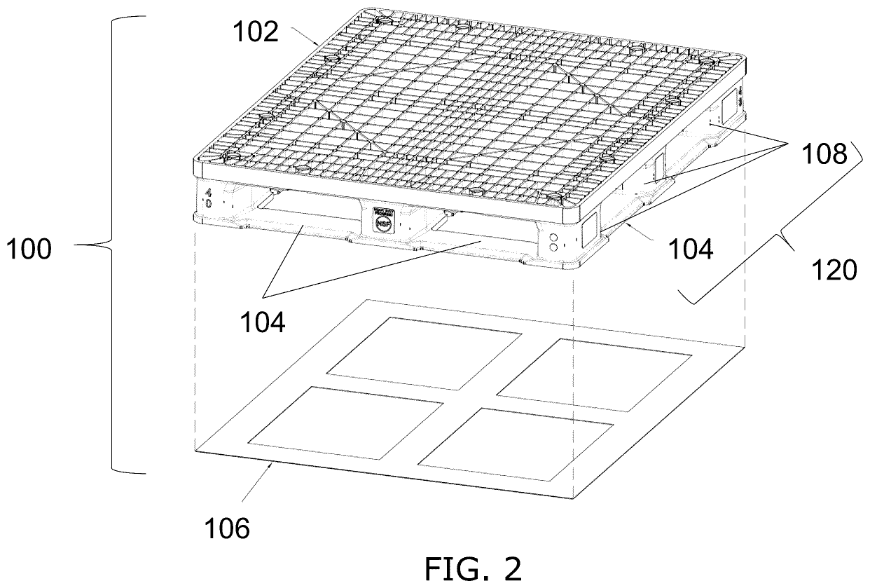

As shown in FIGS. 1 and 2, the pallet deck 102 may comprise an upper deck surface 110 and a lower deck surface 112. The upper deck surface 110 is configured for contacting the goods. In a non-limiting example, the upper deck surface 110 and the lower deck surface 112 includes a generally flat, planar surface having a plurality of holes extending through an entire thickness of the pallet deck 102. The plurality of holes desirably reduces the surface area of the upper deck surface 110 and lower deck surface 112, increases air circulation for goods in contact with the upper deck surface 110, and reduces the overall weight of the pallet 100.

Further, the pallet deck 102 may have any geometry known, including a generally circular, oval, square or rectangular geometry. In certain embodiments, the perimeter shape of the upper deck surface 110 substantially matches that of the lower deck surface 112. Still further, the pallet deck 102 may be molded from thermoplastic or other polymer materials, such as high-density polyethylene (HDPE), polypropylene (PP), etc. The upper deck surface 110 may comprise polymer material that is different from that of the lower deck surface 112.

The pallet deck 102 according to the present disclosure may be formed using conventional or customized computer numerical control (CNC) machines that use data to control and monitor movement and/or activation of machine parts. In an exemplary embodiment, the CNC machine has an extruder. The extruder can be any conventional extruder that extrudes material. For example, the extruder can have a rotating helical screw or a reciprocating plunger. In some aspects, the pellet extruder is part of a large format 3D printer (e.g. a Cartesian printer).

The CNC machine also has a controller that works with a number of motors and drive components in the machine. The motors and drive components control movement of a carrier unit that moves the extruder relative to an article. In addition, the motors and drive units control operation of the extruder. The controller operates each motor to execute programmed motions and functions. One or more sensors send feedback to the controller to monitor the position or condition of the drive units and extruder.

While the present disclosure is described with reference to use of a thermoplastic or other polymer materials as an extruded material, the invention is not so limited. A person of ordinary skill in the art will understand from this disclosure, however, that other extruded materials are within the scope of this invention. The extruded materials compatible with the invention as disclosed herein include all materials which made be made molten and extruded through an extruder including, e.g., plastic materials, plasticized materials, metallic materials, ceramic materials, conductive materials, and adhesives. The feedstock for these materials may be supplied to the extruder in any suitable form, such as, for example, pellet, filament, resin, powder, and wire form.

In operation, the CNC machine has an extruder head and nozzle tip that can be positioned and oriented relative to a target surface. The controller is configured to control operation of motors and receive feedback from sensors to monitor the drive units and extruder. After positioning the extruder head and nozzle tip over the target surface, the controller activates the extruder to extrude material (e.g. thermoplastic materials), which can be repeated according to a predetermined program, pattern or shape, until pallet deck 102 is formed.

Additionally or optionally, the pallet deck 102 may comprise customized changes or refinements, including but not limited to attachment of one or more types of material to change the surface design or geometry of a portion or an entirety of pallet deck 102. Apparatuses and processes for modification of pallet deck 102, including use of conventional or customized computer numerical control (CNC) machines and automatic processes (e.g., 3D printing), may include apparatuses and processes described in U.S. application Ser. No. 17/083,639, the contents of which is incorporated by reference herein in its entirety. Additionally, or optionally, the customized changes or refinements may comprise application of one or more surface enhancements (e.g., a functional surface, ornamental surface, or indicia to the surface) to a portion or an entirety of pallet deck 102. Apparatuses and processes for application of surface enhancement(s) to pallet deck 102 may include apparatuses and processes described in U.S. Provisional Application Ser. No. 62/977,963, the contents of which is incorporated by reference herein in its entirety.

One or more pallet legs 108 extend between the lower deck surface 112 and the base layer 120. The base layer 120 may comprise pallet legs 108. In a non-limiting example, the pallet legs 108 are configured to have a height sufficient to elevate at least the upper deck surface 110 from a pallet floor. In the exemplary embodiment shown in FIGS. 1 and 2, pallet legs 108 are spaced apart from each other and may be positioned along perimeter edges defined by the upper deck surface 110 and/or lower deck surface 112. Alternative embodiments may include one or more pallet legs 108 located centrally between the lower deck surface 112 and the base layer 104. Lower deck surface 112 and base layer 120 may alternatively be joined through a single pallet leg which frames the entire perimeter of the pallet (e.g., forming the sides of a rectangular prism).

The pallet legs 108 may comprise the same or different thermoplastic or polymer material compared to that of the pallet deck 102.

Additionally or optionally, the base layer 120 may comprise a plurality of stringers 104. In an exemplary embodiment, as shown in FIG. 2, attached to a floor-contacting portion of the one or more pallet legs 108 are the plurality of stringers 104. The plurality of stringers 104 may be provided between the two adjacent pallet legs 108, such that the plurality of stringers 104 generally extend along an outer perimeter of the pallet 100, as defined for example, by the perimeter edges of by the upper deck surface 110 and/or lower deck surface 112. Additionally or optionally, the plurality of stringers 104 may be provided along a central region of the pallet deck 102 when one or more adjacent pallet legs 108 are also provided along the central region of the pallet deck 102. The plurality of stringers 104 may provide improved impact strength, stronger structural properties, or other improved reinforcement qualities to the pallet 100. Further, the plurality of stringers and the pallet legs 108 may be connected, such that the pallet legs 108 are spaced apart and the separation allows for the tines of a pallet jack or forklift to be inserted therebetween, for example.

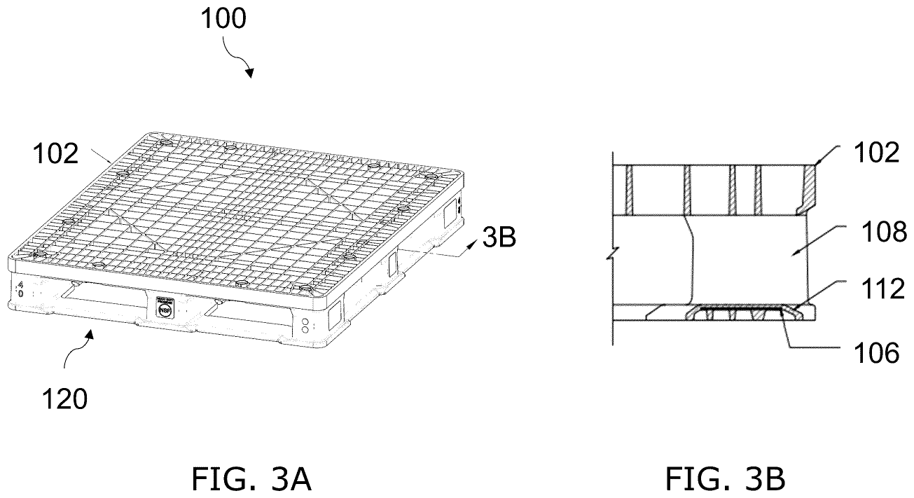

Turning now to FIGS. 3A-3B, a fiber layer 106 may be integrated within the base layer 120, the base layer 120 comprising the plurality of stringers 104, for providing improved reinforcement qualities to the pallet 100. Improved reinforcement qualities may be qualitatively or quantitatively measured, for example, by a reduction of a flexural displacement of the upper deck surface 110 when the upper deck surface 110 is in contact with the goods. Specifically, flexural displacement of pallet 100, particularly of components subject to high tension, such as the upper deck surface 110, may be reduced when the pallet 100 is subjected to edge racking conditions. One skilled in the art would understand from the description herein that edge racking conditions include a pallet racking system typically involving racks that support pallets by only two edges and provide no central support.

The fiber layer 106 may comprise continuous fiber-reinforced materials, such as a fiber-reinforced composite tape, a fiber-reinforced composite sheet, or combinations thereof. In an exemplary embodiment, the fiber layer 106 may comprise continuous fiber reinforced thermoplastic (CFRTP) tape, with fiber including carbon fiber material or glass fiber material, each of which can be combined with an epoxy resin (e.g. PP, PP-Black, polyethylene (PE), polyethylene terephthalate glycol (PETG), aPET-Black, PA6-Black).

Generally, the format, structure, orientation, and other material properties of continuous fiber material 106 may depend on the type and design of pallet 100. Fiber layer 106 may be strategically placed in areas of the pallet 100 which inherently represent weak points in terms of load distribution and/or structural properties. In one non-limiting example, as best shown in FIG. 3B, the fiber layer 106 may be positioned near a lower surface (e.g., closer to the pallet floor) of the plurality of stringers 104. Additionally or optionally, another fiber layer 106 may be integrated with the lower deck surface 112 of the pallet deck 102. Further, another fiber layer 106 may be positioned at an interface between the plurality of stringers 104 and the respective floor-contacting portions of the one or more pallet legs 108. Still further, another fiber layer 106 may be positioned at an interface between the lower deck surface 112 and the respective one or more pallet legs 108. Additionally or optionally, the fiber layer 106 may be similarly integrated with portions of upper deck surface 110.

Concerning the integration of the fiber layer 106 with at least one component of the pallet 100, such as the baser layer 120, the base layer 120 comprising the plurality of stringers 104 and/or the one or more pallet legs 108, the continuous fiber-reinforced materials 106 may be directly transferable to a pallet mold for the purposes of over-molding during a molding process. In one non-limiting example, continuous fiber-reinforced tape 106 may be molded directly into the pallet 100, such that tape 106 is not a secondary assembled part or a pre-molded reinforced component that is then over-molded. Specifically, the fiber-reinforced tape 106 may be molded directly into the pallet 100 using apparatuses and processes, such as conventional or customized computer numerical control (CNC) machines and automatic processes (e.g., 3D printing), as described in U.S. application Ser. No. 17/083,639 and U.S. Provisional Application Ser. No. 62/977,963, the contents of each of which is incorporated by reference herein in its entirety.

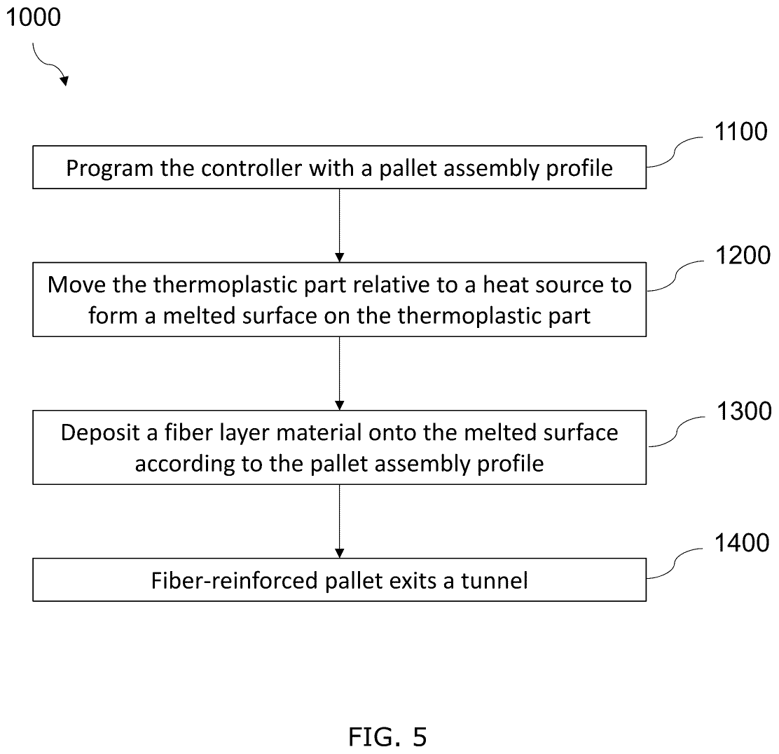

FIG. 5 illustrates an exemplary method of manufacturing a fiber-reinforced pallet. The method 1000 includes one or more steps including forming a melted surface on at least one component of the pallet and depositing a continuous fiber-reinforced additive material onto the melted surface. Additional details of method 1000 are set forth below with respect to the elements of pallet 100.

In a first step 1100, a controller is programmed with a pallet assembly profile.

In a second step 1200, a focused infrared (IR) heater produces a heat flux adequate to melt the top skin or surface of at least one component of pallet, such as the plurality of stringers 104. In particular, the focused IR heater produces the heat flux as the outer perimeter edges of pallet 100 (along which the plurality of stringers 104 extends) is moved relative to the IR heater. The top surface is melted to a desired depth. The depth of melting is controlled based on one or more parameters, including but not limited to intensity setting of the IR heater, the spacing between the heater and the part, and the velocity at which the part is moved relative to the heater. The entire top surface can be melted. Alternatively, only the area(s) of the top surface corresponding to the placement of the fiber layer 106 is (are) melted.

In a third step 1300, an applicator immediately applies continuous fiber-reinforced tape or additive material onto the melted surface of the part. The continuous fiber-reinforced additive material may be in the form of particles, pellets, flakes, regrind, powders or may be sheet fed from one or more rolls. The applicator can move relative to the surface of at least one component of pallet 100 to apply additive material to different areas on the melted surface. The controller controls the movement of the applicator and/or the at least one component of pallet 100 so as to apply additive material according to the pallet assembly profile. The additive material can be a variety of thermoplastic materials, including but not limited to PP, HDPE, polycarbonate (PC), and polyamide (PA). The additive material adheres to the sticky, molten surface of the part after it is applied.

In an additional or optional fourth step 1400, the fiber-reinforced pallet 100 exits a tunnel. The term “exit” as used herein can refer to a moving part being conveyed out of a stationary tunnel, a moving tunnel moving past a stationary part, or a moving part moving out of a moving tunnel traveling at a different speed and/or different direction than the moving part.

Additionally or optionally, one skilled in the art would understand from the description herein that to enable over-molding, several structures or techniques may be employed, including but not limited to support pins, spring pins, applied vacuum to suspend the continuous fiber-reinforced material 106 in strategic locations of the pallet 100, or combinations thereof.

FIG. 5 depicts an example method comprising steps that are performed sequentially in the order recited. However, it should be understood from the description herein that one or more steps may be omitted and/or performed out of the described sequence of the process while still achieving the desired result.

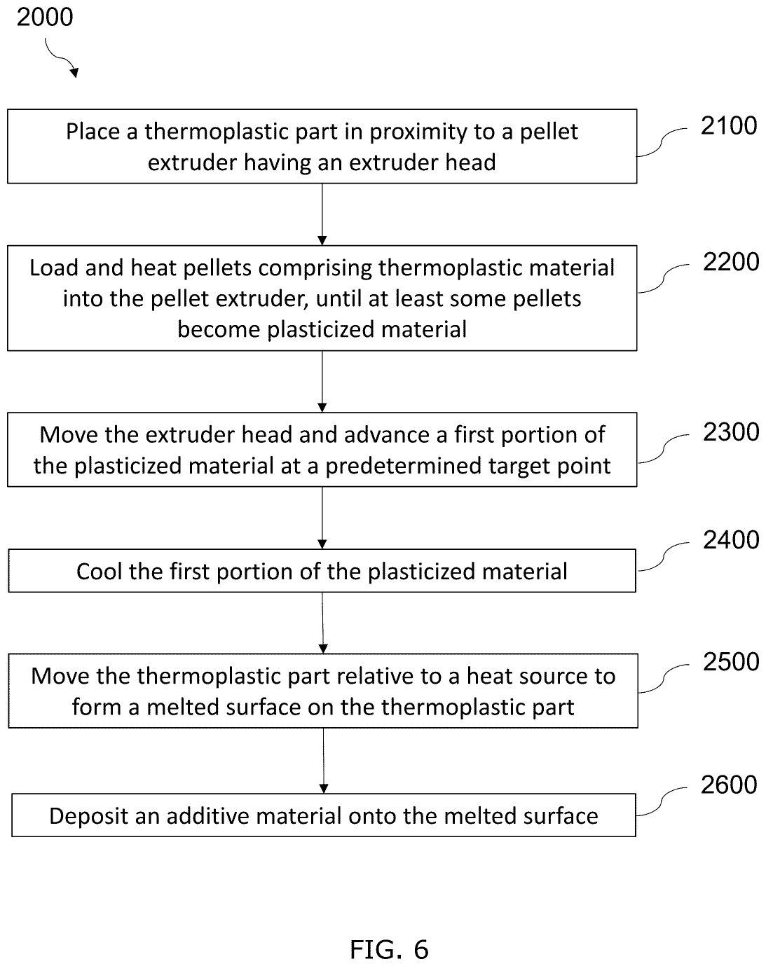

FIG. 6 illustrates another exemplary method of manufacturing a fiber-reinforced pallet, such as method 2000. The method 2000 is similar to the steps and details of method 1000. For example, the method 2000 includes one or more steps including forming a melted surface on at least one component of the pallet and depositing an additive material onto the melted surface. However, method 2000 differs from method 1000 in several respects, as discussed below with respect to the elements of pallet 100.

In a first step 2100, a thermoplastic part is placed in proximity to a pellet extruder, the pellet extruder having an extruder head. In particular, the pallet 100 having a thermoplastic part is placed in proximity to the pellet extruder, such that the outer perimeter edges of pallet 100 (along which the base layer 120, the base layer 120 comprising the plurality of stringers 104 extends) is moved relative to the pellet extruder.

In a second step 2200, pellets comprising thermoplastic material are loaded into the pellet extruder. Additionally or optionally (in a subsequent step), the pellets are heated in the pellet extruder until at least some of the pellets become plasticized material.

In a third step 2300, the extruder head is moved relative to the thermoplastic part so that the extruder head faces a predetermined target point on a surface of the thermoplastic part. Additionally or optionally (in a subsequent step), a first portion of the plasticized material is advanced out of the extruder head and directly onto the surface of the thermoplastic part at the predetermined target point. In particular, the extruder head is moved such that the extruder head faces the outer perimeter edges of pallet 100 (along which the base layer 120, the base layer 120 comprising the plurality of stringers 104 extends). Additionally or optionally (in a subsequent step), the first portion of the plasticized material is advanced onto the entire top (or bottom) surface of the base layer 120 comprising the plurality of stringers 104. Alternatively, the first portion of the plasticized material is advanced only onto the area(s) of the top surface corresponding to the placement of the fiber layer 106 is (are). The characteristics of the advancement of the first portion of the plasticized material is controlled based on one or more parameters, including but not limited to the spacing between the extruder head and the part, and the velocity at which the first portion of the plasticized material is deposited onto the pallet 100.

In a fourth step 2400, said first portion of the plasticized material is cooled to permanently fuse it to the surface of the thermoplastic part at the predetermined target point.

In a fifth step 2500, the surface of thermoplastic part is moved relative to a heat source to form a melted surface on the thermoplastic part. This step is similar to step 1200 of method 1000, as described above.

In a sixth step 2600, an additive material is deposited onto the melted surface, entangled with the melted surface; and the melted surface is cooled. This step is similar to step 1300 of method 1000, as described above. In particular, the additive material may include material capable of creating a fiber layer such as fiber-reinforced tape or other fiber-based material. The additive material can additionally or alternatively be a variety of thermoplastic materials, including but not limited to PP, HDPE, polycarbonate (PC), and polyamide (PA). The additive material adheres to the sticky, molten surface of the part after it is applied.

FIG. 6 depicts an example method comprising steps that are performed sequentially in the order recited. However, it should be understood from the description herein that one or more steps may be omitted and/or performed out of the described sequence of the process while still achieving the desired result.

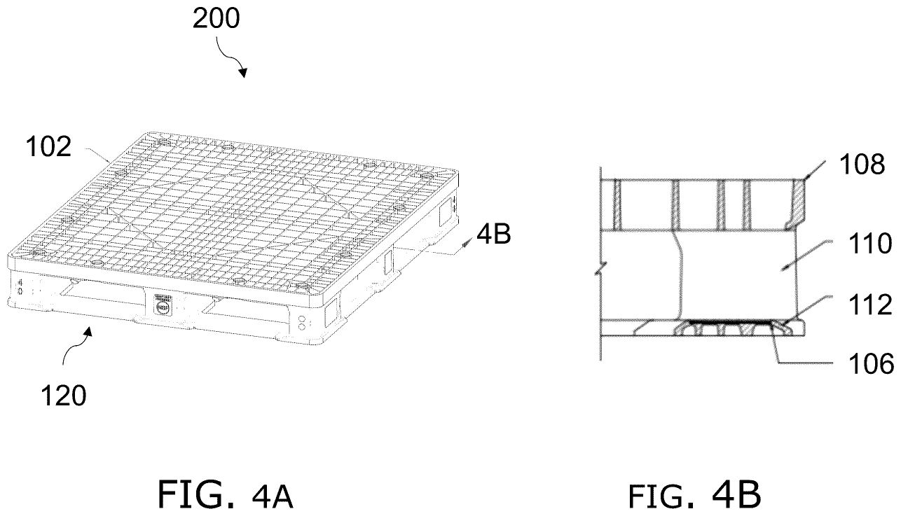

Another embodiment of the pallet 100 according to the present invention is illustrated in FIGS. 4A-4B. The components of this embodiment, such as pallet 200, generally correspond to the components of pallet 100. However, this embodiment differs from the first embodiment described above in some respects. In one example, the fiber layer 106 is positioned in a central region between an upper and lower surface of the plurality of stringers 104.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A reinforced plastic pallet comprising:
a pallet deck having a lower deck surface and an opposing upper deck surface, the upper deck surface configured for contacting goods;
one or more pallet legs extending between the lower deck surface and a base layer, wherein the base layer is reinforced with a fiber layer.

2. The reinforced plastic pallet of claim 1, wherein the fiber layer is a multilayered composite fiber having a first fiber layer and a plurality of second fiber layers overlapped over or under the first fiber layer in a single, parallel direction.

3. The reinforced plastic pallet of claim 1, wherein the fiber layer is a multilayered composite fiber having a first fiber layer and a plurality of second fiber layers overlapped over or under the first fiber layer, and wherein each of the plurality of second fiber layers are overlapped over or under the first fiber layer at a respective angle relative to the first fiber layer.

4. The reinforced plastic pallet of claim 1, wherein the angle is between 0 and 90 degrees.

5. The reinforced plastic pallet of claim 1, wherein the fiber layer is positioned near a lower surface of the base layer.

6. The reinforced plastic pallet of claim 1, wherein the fiber layer is positioned in a central region between an upper and lower surface of the base layer.

7. The reinforced plastic pallet of claim 1, wherein the base layer comprises a plurality of stringers.

8. The reinforced plastic pallet of claim 7, wherein the fiber layer comprises one or more of a fiber-reinforced composite tape, a fiber-reinforced composite filament, and a fiber-reinforced composite sheet.

9. The reinforced plastic pallet of claim 7, wherein the fiber layer comprises one or more of an aramid fiber, a carbon fiber, a glass fiber, carbon reinforced plastic fiber, a glass reinforced plastic fiber, a basalt fiber, and a metal fiber.

10. The plastic pallet of claim 1, at least one of the upper deck surface and the lower deck surface is reinforced with one or more fiber layers.

11. The plastic pallet of claim 1, further comprising another fiber layer positioned at an interface between the base layer and the one or more pallet legs.

12. The plastic pallet of claim 1, further comprising another fiber layer positioned at an interface between the lower deck surface and the one or more pallet legs.

13. The plastic pallet of claim 1, wherein at least the upper deck surface comprises antimicrobial material.

14. A method for manufacturing a fiber-reinforced pallet having a thermoplastic part, the method comprising the steps of:
A. programming a controller with a pallet assembly profile;
B. moving the thermoplastic part relative to a heat source to form a melted surface on the thermoplastic part;
C. depositing a fiber layer material onto the melted surface according to the pallet assembly profile.

15. The method of claim 11, further comprising the steps of:
D. entangling the fiber-reinforced material with the melted surface; and
E. cooling the melted surface.

16. The method of claim 14, wherein the step of moving the thermoplastic part relative to the heat source comprises moving the thermoplastic part at different speeds and/or different directions.

17. The method of claim 14, further comprising the step of applying heat to the additive material and melted surface after the step of depositing the additive material onto the melted surface.

18. The method of claim 14, wherein the fiber layer materials comprise one or more of an aramid fiber, a carbon fiber, a glass fiber, carbon reinforced plastic fiber, a glass reinforced plastic fiber, a basalt fiber, and a metal fiber.

19. The method of claim 18, further comprising the step of flattening and mating the additive material with the melted surface.

20. The method of claim 14, wherein the step of depositing an additive material onto the melted surface comprises moving an applicator containing the additive material over the melted surface.

21. The method of claim 20, wherein the applicator is part of a CNC machine having a controller.

22. The method of claim 21, wherein the CNC machine is a Cartesian printer.

23. The method of claim 22, wherein the CNC machine is a CNC controlled robotic arm.

24. A method for manufacturing a fiber-reinforced pallet having a thermoplastic part, the method comprising the steps of:
A. placing a thermoplastic part in proximity to a pellet extruder, the pellet extruder having an extruder head;
B. loading pellets comprising thermoplastic material into the pellet extruder;
C. heating the pellets in the pellet extruder until at least some of the pellets become plasticized material;
D. moving the extruder head relative to the thermoplastic part so that the extruder head faces a predetermined target point on a surface of the thermoplastic part;
E. advancing a first portion of the plasticized material out of the extruder head and directly onto the surface of the thermoplastic part at the predetermined target point; and
F. cooling said first portion of the plasticized material to permanently fuse it to the surface of the thermoplastic part at the predetermined target point.

25. The method of claim 24, further comprising the steps of:
G. moving the surface of thermoplastic part relative to a heat source to form a melted surface on the thermoplastic part;
H. depositing an additive material onto the melted surface;
I. entangling the additive material with the melted surface; and
J. cooling the melted surface.

26. The method of claim 25, wherein the plasticized material and the additive material form a functional surface on the surface of the thermoplastic part.

27. The method of claim 26, wherein the surface of the thermoplastic part comprises a lower deck surface of a pallet deck.

28. The method of claim 25, wherein the plasticized material and the additive material forms an ornamental surface on the surface of the thermoplastic part.

29. The method of claim 24, wherein steps D, E and F are repeated at a plurality of predetermined target points on the surface of the thermoplastic part.

30. The method of claim 25, wherein steps G, H, I, and J are repeated at a plurality of predetermined target points on the surface of the thermoplastic part.

31. The method of claim 24, wherein the pellets are formed of the same material as the thermoplastic part.

32. The method of claim 24, wherein the pellet extruder is part of a CNC machine having a controller.

33. The method of claim 24, wherein the controller controls movement of the extruder head.

34. The method of claim 33, further comprising the step of programming the controller to move the extruder head to one or more positions relative to the thermoplastic part.

35. The method of claim 24, wherein the pellet extruder is connected to a large format 3D printer.

36. The method of claim 35, herein the 3D printer is a Cartesian printer.
